(19) United States
(12) Patent Application Publication
(10) Pub. No.: US 2008/0193748 A1
(43) Pub. Date: Aug. 14, 2008

(54) Adhesive Film

(75) Inventor: Ralph Erdmann, Wiesbaden (DE)

Correspondence Address: PAUL AND PAUL, 2000 MARKET STREET, SUITE 2900, PHILADELPHIA, PA, 19103, US

(73) Assignee: PüTZ GMBH & CO. FOLIEN KG, Taunusstein-Wehe (DE)

(21) Appl. No.: 11/914,790

(22) PCT Filed: Apr. 6, 2006
(86) PCT No.: PCT/EP06/61411

§ 371 Date: Dec. 18, 2007

(30) Foreign Application Priority Data
May 20, 2005 (DE) 10 2005 023 280.9

(51) Int. Cl. C09J 7/02

(52) U.S. Cl. 428/336; 428/352; 428/337; 428/355 EN; 428/334

(57) ABSTRACT

The present invention concerns an adhesive film for releasably holding articles. In addition the present invention concerns a conveyor belt having such an adhesive film for transporting articles, wherein the articles are or can be releasably connected to the conveyor bell. In order to provide an adhesive film of low stretchability, high tearing strength and high tearing-propagation strength and of the lowest possible weight, to which articles to be transported can be temporarily stuck and with which said articles can be conveyed at high speed, it is proposed in accordance with the invention that the adhesive film has at least one carrier layer comprising a first polymer material which is stretchable by at most 50% at least in a direction X and an adhesive layer comprising a second, non-scalable polymer material which is more greatly stretchable than the carrier layer at least in the direction X.

The present invention concerns an adhesive film for releasably holding articles. The invention further concerns a conveyor belt for conveying articles, wherein the articles are or can be releasably connected to the conveyor belt and wherein the conveyor belt has an adhesive film.

In many industrial manufacturing processes it is important in particular to achieve the largest possible number of end products from the respective manufacturing process in the shortest possible time as in particular it is possible to save on production costs by virtue of an increased level of productivity per unit of time. Usually, in automated manufacturing processes, the various individual components of an end product are firstly brought together along a production line and are then processed together and/or joined together. Both the product which is gradually produced in that fashion and also the components required for producing the product must be conveyed at high speed to and through the production line, to afford the effectiveness called for hereinbefore. There are various conveyor mechanisms for that purpose, of which the continuously moving conveyor or assembly belt is the best known. In the case of some conveyor bells the conveyor belt admittedly comes into contact with the article to be conveyed, but without an at least temporarily fixed connection being afforded between the bell and the article being conveyed. In contrast, in the case of other types of conveyor belt, the articles being conveyed are held by the conveyor belt or mechanisms fixed thereon, by the formation of a temporary fixed connection thereto. In some conveyor belt configurations that connection to the article to be transported is formed by way of an adhesive agent or glue. Substances on which the following demands are to be made are considered as the adhesive or glue. Firstly those substances must be such that they can be so firmly connected to the conveyor or transport belt and also to the article being transported that the article being transported is held fast on the conveyor belt and cannot come spontaneously loose from the belt. Secondly however the connection between the conveyor belt and the article being transported must be releasable again, more precisely just at the moment at which the article being transported has reached its destination, that is to say the location at which the article is to be processed. Thirdly, the connection between the conveyor belt and the adhesive or glue must be such that neither the conveyor belt nor the article being transported are damaged, and fourthly it is necessary to be able to implement separation of the connection without involving a high level of complication and expenditure, quickly and without any residue, at the destination of the article.

Conveyor belts which comprise polymer films in belt form are known from the state of the art. Adhesive locations are provided on those film belts at predetermined spacings or a continuous adhesive layer is provided on the belts at one side. Usually stamped-in openings are provided along the longitudinal edges of those conveyor belts, so that gears can suitably engage into the openings for guidance and drive purposes. The stamped-in openings frequently also serve to achieve a certain saving on material and reduction in weight. At the same time however in the usual film conveyor belts those stamped-in openings are also a weak point as incipient tears can easily occur in the conveyor belt material, starting from those openings, and those tears then spread through the material and can result in the belt tearing away. It will be appreciated that such events are absolutely to be avoided as they generally result in the entire production procedure breaking down.

In the case of the film conveyor belts known from the state of the art however those events frequently occur as generally operation is implemented at very high conveyor speeds whereby the film material is very heavily loaded. In addition the usual film conveyor belts are generally not elastic, that is to say not stretchable, as stretchable film belts can only be guided with difficulty in a controlled and uniformly tensioned fashion over roller systems. Therefore biaxially oriented film belts which have been biaxially stretched beyond their stretch limit are usually employed.

Stretching polymer films provides that the molecular chains are monoaxially or biaxially oriented in the stretching direction. As a result the film stretchability is reduced to a minimum. Biaxially oriented films have a very high level of tearing strength but if they have already suffered from incipient tearing at a location, they have only a very low resistance to further tearing, that is to say existing tears can be propagated very rapidly and very easily over the film material, which generally leads to the conveyor belt tearing away.

There is therefore a need for conveyor films to which articles to be transported can be releasably connected and which do not suffer from incipient tearing at high conveyor speeds over roller systems under a tensile stress, not even when stamped-in openings are provided on the belt. There is therefore in particular a need for adhesive films of low stretchability and of high primary tearing strength and high tearing-propagation strength. Furthermore an adhesive film which has the aforementioned features should also be of the lowest possible weight.

Therefore the object of the present invention is to provide an adhesive film of low stretchability, high tearing strength and high tearing-propagation strength and of the lowest possible weight, to which articles to be conveyed can be temporarily stuck and with which said articles can be conveyed at high speed.

According to the invention that object is attained by an adhesive film for releasably holding articles which is characterized in that it has at least one carrier layer comprising a first polymer material which is stretchable by at most 50% at least in a direction X and an adhesive layer comprising a second, non-sealable polymer material which is more greatly stretchable than the carrier layer at least in the direction X.

The adhesive film according to the invention is a multi-layer film or a film laminate comprising at least two layers which are different from each other and of which one has a primarily carrying, stability-imparting function (carrier layer) and the other serves primarily to afford a connection between the adhesive film and the article to be transported (adhesive layer). The adhesive layer of the film according to the invention however also has a second significant function, namely that of improving the tear-propagation resistance of the film laminate. The stretchability of the polymer material of the adhesive layer, which is higher in a given direction X, in comparison with the relatively low stretchability of at most 50% of the carrier layer in that direction, provides that the tearing strength and in particular the tearing-propagation strength of the adhesive film is markedly improved in comparison with a film which only comprises polymer material which is relatively little stretchable.

Here the term “films” is used to denote materials which are present in web form and which are preferably a few millimeters thick and which particularly preferably are below I mm in thickness. The adhesive film according to the invention has different layers, wherein the layers are preferably themselves in the form of films. Therefore the terms “carrier layer” and “adhesive layer” respectively also embrace the terms “carrier layer film” and “adhesive layer film” respectively. Both carrier layer and also adhesive layer can however also be provided in the adhesive film in non-film-like manner, for example if in manufacture one of the two layers is applied to the other layer which is present in film-like manner.

Embodiments with a relatively low stretchability of the polymer material of the carrier layer are preferred as those films can advantageously be used in the form of film belts which are to be guided in a controlled and uniformly tensioned manner over roller systems. Thus in preferred embodiments the stretchability of the carrier layer at least in the direction X is at most 30% and in particularly preferred embodiments at most 15%. If particularly high tensile forces occur in regular proper use, stretchability of at most 3% is preferred, while in specific configurations a stretchability of at most 1% is preferred.

Embodiments in which the carrier layer is stretchable by at least 1%, preferably by at least 3%, at least in the direction X, are also particularly preferred, as a certain minimum stretchability can be of advantage if tensile forces which jerkily occur are to be carried, for example when starting a conveyor belt. Thus specific embodiments are characterized in that the stretchability of the carrier layer is in the range of between 1 and 30%. Furthermore embodiments are preferred in which the stretchability of the carrier layer is in the range of between 1 and 15% or in the range of between 1 and 3%.

The embodiments referred to in the last two paragraphs are preferred in particular when they are intended for uses in relation to which the adhesive film according to the invention is to be used in the form of film belts which are used with high belt travel speeds and/or which are subjected to high tensile forces in ordinary use.

Preferably the stretchability of the adhesive layer is approximately twice as high as that of the carrier layer. Preferably the stretchability of the adhesive layer is between about 3 and 10 times higher than that of the carrier layer. In especial, particularly preferred embodiments, the adhesive layer is more stretchable by between about 5 and 7 times than the carrier layer.

According to the invention the adhesive layer comprises a non-sealable polymer material, preferably a non-sealable polymer film. A polymer material is scalable if it melts upon welding to itself or to other materials in such a way that the connection afforded thereby cannot be separated again without damaging the scalable material. In regard to a connection of that kind, it is also referred to as a fixed sealing connection. In contrast the connection of a non-sealable material to itself or to another material, for example by welding, is readily separable again in such a way that the non-sealable material is not damaged. In other words, articles can be embedded in the non-sealable material and can adhere thereto, in which case those articles can be peeled off the non-sealable material again without the non-sealable material being damaged thereby or indeed destroyed. A connection of that kind is also referred to as a peelable connection.

Stated in another way, the adhesive film according to the invention therefore includes on the one hand a carrier layer of low stretchability, wherein the carrier layer can comprise scalable (fixed-sealing) or peelable polymer and on the other hand an adhesive layer of peelable (non-fixed-sealing) polymer which is laminated onto the carrier layer and which is more greatly stretchable than the carrier layer.

Preferably the peeling force which has to be applied in order to detach articles fixed to the adhesive layer therefrom again is lower than the tearing strength of the carrier film. It is further preferred that the peeling force which has to be applied to detach articles fixed to the adhesive layer from it again is also less than the adhesive force between the adhesive layer and the carrier layer.

In a preferred embodiment of the present invention the adhesive layer is such that, by an increase in temperature, bringing it into contact with the articles to be conveyed and subsequent, cooling, it can be so firmly connected to the articles being conveyed that the articles can be satisfactorily transported and at their destination can be peeled off the adhesive layer again. In this embodiment the connection between the articles being conveyed and the adhesive film is therefore formed by at least the polymer material of the adhesive layer being raised to an elevated temperature in the region in which the connection is to be produced. In that way the polymer material of the adhesive layer becomes somewhat softer so that the articles to be conveyed can be better pressed into the polymer matrix, which is now softer, of the adhesive layer, whereby they are so connected to the adhesive layer that they are held to the conveyor film thereby as soon as the temperature of the adhesive layer falls again after contact has been made between the adhesive layer and the article to be conveyed. The article which is connected to the adhesive film in that way can then be readily removed again from the adhesive film easily at its destination. In a specific embodiment of the invention the connection between the articles being conveyed and the adhesive layer can first be released again by the temperature of the adhesive layer being raised again at the destination or shortly before it.

Usually the increase in temperature of the adhesive layer is effected from the direction in which the adhesive layer of the adhesive film faces. It will be noted however that the increase in temperature can also be produced from the opposite side of the adhesive film, for example by means of a sealing jaw which bears against the carrier layer of the adhesive film. It is therefore preferred in some embodiments of the present invention that the Vicat softening temperature of the carrier layer is higher than the Vicat softening temperature of the adhesive layer as, upon an increase in temperature through the carrier layer, the carrier layer would otherwise itself be excessively greatly softened, which can lead to unwanted dimpling or rippling or shrinkage of the carrier layer. In that case the Vicat softening temperature is the temperature at which a steel needle of a 1 mm² cross-section under a defined loading penetrates to a depth of 1 mm into an increasingly heated polymer specimen.

In a particularly preferred feature the stretchability of the carrier layer is reduced by the polymer material of that layer being oriented. Accordingly the carrier layer preferably comprises monoaxially oriented polymer material and particularly preferably biaxially oriented polymer material. As the adhesive layer is to involve a higher level of stretchability than the carrier layer it preferably comprises non-oriented polymer material. In some embodiments however the polymer material of the adhesive layer is monoaxially but not biaxially oriented.

The polymer materials preferably used for the carrier layer include polypropylene or polyester. A particularly preferred carrier layer polymer is polyethyleneterephthalate. The adhesive layer preferably comprises polyethylene, polypropylene or ethylene-vinyl acetate-copolymer.

In particularly preferred embodiments the layer thickness of the carrier layer is between 10 and 100 μm. Embodiments involving a carrier layer thickness of between 20 and 80 μm are particularly preferred. In general terms the principle that applies is that the layer thickness is always to be selected to be as small as possible in order to minimize the overall weight of the conveyor film. It is to be noted in that respect however that greater carrier layer thicknesses are advantageous in particular when the increase in temperature is effected through the carrier layer, for example if a sealing jaw bears “from the back” against the adhesive film (against the outside surface of the carrier layer). As the application of heat through that carrier layer can result in deformation phenomena if the carrier layer is of excessively small layer thicknesses, it is advantageous in that case if the layer thickness is at least 50 μm. Below about 10 μm the tearing strength of the carrier layer is no longer high enough for many uses so that it is preferable for the carrier layer thickness to be at least 10 μm. Particularly good tearing strength-layer thickness ratios have been established for carrier layer thicknesses of between 20 and 80 μm. Layer thicknesses of between 80 and 100 μm are advantageous when coloration of the adhesive film is desired. Coloration of the adhesive film can be desired for aesthetic reasons or may also be required if control of the conveyor film is effected by photoelectric cells which must optically recognize the belt in order to be able to monitor and suitably control the proper movement thereof.

In specific embodiments of the present invention the adhesive layer thickness is between 20 and 80 μm. In particularly preferred embodiments the thickness of the adhesive layer is between 30 and 50 μm.

The principle of the smallest possible layer thickness also applies to the adhesive layer. It is however also the case that the thickness of the adhesive layer must in any case be high enough for it to impart the required tearing strength and/or tearing-propagation strength thereto. In addition the thickness of the adhesive layer must be sufficiently high that the articles being conveyed can be so embedded in the film layer body that they are sufficiently firmly held by the adhesive layer at given conveyor speeds.

The adhesive films of the present invention can be produced by co-extrusion, for example with blowing tools for two-layer films or with multi-layer tools in which two flows of molten material at different temperatures are brought together shortly before they issue. The film laminates according to the invention can however also be obtained by post-co-extrusion processes which provide for extruding onto a freshly manufactured single-layer film, the material of the second film layer. Furthermore the material of a second film layer can also be obtained by spreading it with a squeegee onto the first film layer or by applying it thereto with rollers. In addition two existing films can also be laminated together by calendering.

In particularly preferred embodiments of” the present invention a layer of polymer adhesive is provided between the carrier layer and the adhesive layer, to join the two film layers. The layer thickness of that polymer adhesive layer is preferably between 0.5 and 5 μm. Polymer adhesive layers of a thickness of between 1 and 3 μm are particularly preferred.

Preferably the polymer adhesive is suitable for increasing the strength of the join between the carrier layer and the adhesive layer in such a way that that join can better withstand the force which is applied to peel off the articles being conveyed. Particularly preferably the polymer adhesive produces a firm connection between the carrier layer and the adhesive layer, which can no longer be released.

The adhesive films according to the invention are suitable for conveying the most widely varying articles. In particular the adhesive films according to the invention are suitable for conveying relatively light components in a manufacturing process. Preferred embodiments of the adhesive film according to the invention are or can be for example releasably connected to articles which are selected from microchips, printed antennas, labels, emblems, loops and bands or tapes.

It is particularly preferred if an adhesive film in accordance with the present invention is a component part of a conveyor belt for conveying articles, in which respect the term conveyor belt is used here to denote a belt which for example is driven by way of rollers at a relatively high speed either in a circulatory movement or only in one direction. If the adhesive film is a component part of a conveyor belt the carrier layer of the adhesive film comprises polymer material which is oriented at least in the longitudinal direction of the conveyor belt. Correspondingly, the adhesive layer of that film preferably comprises a polymer material which is not oriented at least in the longitudinal direction of the conveyor belt.

It is noted that all features as are to be found from the present description and the claims from the point of view of the man skilled in the art can be combined both individually and also in any combinations with others of the features or groups of features disclosed here unless that has been expressly excluded or such combinations would be technically impossible or meaningless. That applies even if the individual features or groups of features have been specifically described only in connection with given further features. It is only for the sake of brevity and readability of the description that the comprehensive representation of all conceivable combinations of features is not set forth here. By way of example however some of such combinations of features as well as further advantages, features and possible uses of the present invention will be apparent from the following examples.

### EXAMPLE 1

In the context of a manufacturing process for sausage goods, a loop was to be provided at an end of each sausage for hanging it up. The conveyor rate was 150 sausages per minute, that is to say accordingly 150 loops per minute had to be provided for fitting to the ends of the sausages. That operation of providing the loops was carried out by means of a film belt on which the sausage loops were provided at predetermined spacings. At the appropriate processing location in the production installation the loops were to be automatically rapidly removed from the conveyor belt and fixed by knotting to the sausage ends.

For that purpose, an adhesive Rim according to the invention was used as the conveyor bell, wherein the carrier layer comprised biaxially stretched and thus biaxially oriented PET (polyethyleneterephthalate) and the adhesive film comprised non-oriented (unstretched) non-sealable polypropylene film (UPP). The stretchability of the carrier layer in the longitudinal direction of the conveyor belt was about 50%, that is to say the conveyor belt could be stretched in the longitudinal direction by about 3% of the original length (conveyor belt in the stress-relieved condition) without the material tearing. The adhesive layer had a stretchability of about 300%. The melting point of the carrier layer polymer was 260° C. and its Vicat softening point was 120° C. The melting point of the adhesive layer polymer was 160° C. and its Vicat softening point was 90° C. The layer thickness of the carrier layer was 23 μm and the thickness of the adhesive layer was 40 μm. Between the carrier film and the adhesive film there was a lamination adhesive layer of a layer thickness of 1 μm. The loops consisted of polypropylene and were pressed into the adhesive layer in transverse relationship to the longitudinal direction of the conveyor belt at an application temperature of about 110° C. A sealing layer of ethylene-vinyl acetate-copolymer film was provided on the adhesive layer with the loops adhering thereto.

In operation it was found for the above-described film belt that, at a rate of 150 sausages which were provided with a loop per minute and with a total test time of 24 hours the film belt was perfectly passed over the roller system and the film belt was not torn away.

### EXAMPLE 2

The test conditions for example 2 were very substantially the same as those of example 1 except that the layer thickness of the carrier layer was 75 μm. In this example the carrier layer thickness was selected to be somewhat greater as the sealing jaw for heating the adhesive film when causing the sausages loops to adhere to the adhesive film during processing acted thereon “from the back”. In other words in this example the sealing jaw was bearing against the free outside surface of the carrier layer so that the temperature was transmitted through carrier layer to the adhesive layer in order to soften the adhesive layer polymer for removal of the loops.

It was found in use that the film belt used was passed over the roller system perfectly over 24 hours without the conveyor belt suffering from incipient tearing or being torn away. In contrast thereto use of a conveyor film in accordance with example 1 was not satisfactory as the faster heating of the thinner carrier layer of the adhesive film of example 1 meant that the adhesive film became “restless”, that is to say the film suffered from shrinkage effects and dimpling or rippling in the carrier layer. That conveyor film therefore could not be used.

### EXAMPLE 3

Example 3 also involved the use of an adhesive film as a conveyor belt which involved the basic structure of the adhesive film described in example 1. The adhesive film of this example only differed from that of example 1 in that the adhesive layer was 60 μm in thickness and the loops consisted of hemp fibers. The hemp fiber loops were of a somewhat greater thickness than the polypropylene loops of example 1. The adhesive strength of the hemp loops on the adhesive film of example 1 was therefore not satisfactory, that is to say individual hemp loops spontaneously detached from the adhesive layer during transport and were therefore not available for further processing at the destination. In contrast the somewhat thicker adhesive layer of example 3 afforded markedly better adhesive strength in connection with the hemp loops so that almost perfect processing was possible. Spontaneous detachment of the loops from the adhesive layer occurred only sporadically. That however could be overcome by the loops being brought into contact over the full surface area with the adhesive layer by the loops being oriented in the longitudinal direction of the conveyor belt.

1. An adhesive film for releasably holding articles characterized in that it has at least one carrier layer comprising a first polymer material which is stretchable by at most 50% at least in a direction X and an adhesive layer comprising a second, non-sealable polymer material which is more greatly stretchable than the carrier layer at least in the direction X.

2. An adhesive film as set forth in claim 1 characterized in that the adhesive layer is between about 2 and 10 times more stretchable than the carrier layer, preferably more stretchable by between 3 and 7 times and particularly preferably between 5 and 7 times.

3. An adhesive film as set forth in claim 1 characterized in that the carrier layer is stretchable by at most 30% at least in a direction X, preferably stretchable by at most 15% and particularly preferably stretchable by at most 3%.

4. An adhesive film as set forth in claim 1 characterized in that the carrier layer is stretchable by at least 1% at least in the direction X, preferably by at least 3%.

5. An adhesive film as set forth in claim 1 characterized in that the adhesive layer is such that it can be fixedly connected to the articles by an increase in temperature, being brought, into contact with the articles and subsequent cooling, wherein said connection is releasable again.

6. An adhesive film as set forth in claim 5 characterized in that the Vicat softening temperature of the carrier layer is higher than the Vicat softening temperature of the adhesive layer.

7. An adhesive film as set forth in claim 1 characterized in that the carrier layer comprises monoaxially, preferably biaxially oriented polymer material.

8. An adhesive film as set forth in claim 1 characterized in that the carrier layer comprises polypropylene or polyester.

9. An adhesive film as set forth in claim 1 characterized in that the adhesive layer comprises at most monoaxially oriented polymer material.

10. An adhesive film as set forth in claim 1 characterized in that the adhesive layer comprises polyethylene, polypropylene or ethylene-vinyl acetate-copolymer.

11. An adhesive film as set forth in claim 1 characterized in that the layer thickness of the carrier layer is between 10 and 100 μm, preferably between 20 and 80 μm.

12. An adhesive film as set forth in claim 1 characterized in that the layer thickness of the adhesive layer is between 20 and 80 μm, preferably between 30 and 50 μm.

13. An adhesive film as set forth in claim 1 characterized in that it has a layer of polymer adhesive between the carrier layer and the adhesive layer, wherein the layer thickness of the polymer adhesive layer is preferably between 0.5 and 5 μm, particularly preferably between 1 and 3 μm.

14. An adhesive film as set forth in claim 5 characterized in that it is or can be releasably connected to articles which are selected from microchips, printed antennas, labels, emblems, loops and bands or tapes.

15. A conveyor belt for conveying articles, wherein the articles are or can be releasably connected to the conveyor belt, characterized in that the conveyor belt has an adhesive film as set forth in claim 1.

16. A conveyor belt as set forth in claim 15 characterized in that the carrier layer of the adhesive film comprises polymer material which is oriented at least in the longitudinal direction of the conveyor belt,

17. A conveyor belt as set forth in claim 15 characterized in that the adhesive layer of the adhesive film comprises polymer material which is non-oriented at least in the longitudinal direction of the conveyor belt.

18. A conveyor belt as set forth in claim 16 characterized in that the adhesive layer of the adhesive film comprises polymer material which is non-oriented at least in the longitudinal direction of the conveyor belt.
